(19) United States
(12) Patent Application Publication
(10) Pub. No.: US 2024/0178469 A1
(43) Pub. Date: May 30, 2024

(54) METHOD AND APPARATUS FOR MONITORING ENERGY STOTAGE CELL ABNORMALITY, ELECTRONIC DEVICE, AND MEDIUM

(71) Applicant: Shanghai Makesens Energy Storage Technology Co., Ltd., Shanghai (CN)

(72) Inventors: Weikun WU, Shanghai (CN); Danfei GU, Shanghai (CN); Peng DING, Shanghai (CN); Xiao YAN, Shanghai (CN); Enhai ZHAO, Shanghai (CN); Haowen REN, Shanghai (CN); Decheng WANG, Shanghai (CN); Yuan FENG, Shanghai (CN)

(73) Assignee: Shanghai Makesens Energy Storage Technology Co., Ltd., Shanghai (CN)

(21) Appl. No.: 18/518,632

(22) Filed: Nov. 24, 2023

(30) Foreign Application Priority Data
Nov. 25, 2022 (CN) 2022114937762

(51) Int. Cl. H01M 10/48

(52) U.S. Cl. CPC H01M 10/482

(57) ABSTRACT

A method and an apparatus for monitoring energy storage cell abnormality, an electronic device, and a medium are provided. The method includes: obtaining valid state data of a first cell in a battery module at a preset time; obtaining a discrete statistical state characteristic of the first cell based on the valid state data of the first cell; calculating distances between the discrete statistical state characteristic of the first cell and discrete statistical state characteristics of each remaining cells in the battery module separately, averaging the set of distances, to obtain a distance characteristic associated with the first cell; and determining whether the first cell is abnormal based on the distance characteristic of the first cell. Consistency monitoring of each cell in the battery module is implemented based on the state data of each cell, so that an early warning indicative of a possible fault can be issued.

### CROSS REFERENCE TO RELATED APPLICATION

The present application claims the benefit of priority to Chinese Patent Application No. 202211493776.2, entitled “METHOD AND APPARATUS FOR MONITORING ENERGY STOTAGE CELL ABNORMALITY, ELECTRONIC DEVICE, AND MEDIUM”, filed with CNIPA on Nov. 25, 2022, the disclosure of which is incorporated herein by reference in its entirety for all purposes.

### FIELD OF THE INVENTION

The present disclosure generally relates to the field of battery safety, and in particular, to a method and an apparatus for monitoring energy storage cell abnormality, an electronic device, and a medium.

### BACKGROUND OF THE INVENTION

As energy storage technology advances rapidly, ensuring the safe use of energy storage cells (or cells) in various environments is of utmost importance. To guarantee battery safety, it's crucial to remove individual cells with subpar energy storage performance and significant inconsistency variations during the operation of a battery module. Additionally, it's necessary to categorize the degree of inconsistency among the individual cells within the module. Moreover, during routine inspections, cells with large inconsistency variations should receive enhanced maintenance. This, coupled with appropriate maintenance measures, can help prevent hazards such as combustion and explosions.

The performance and lifespan of a battery module are directly influenced by the consistency of each cell within the module. Therefore, ensuring the consistency of each cell within the module is key to maintaining the module's performance. Current technologies primarily determine the consistency of each cell in the module based on the cell's internal resistance, voltage difference, and capacity difference. However, this method is too complex and not suitable for consistency checks on a large number of cells, resulting in relatively low monitoring efficiency for the battery module.

### SUMMARY OF THE INVENTION

A first aspect of the present disclosure provides a method for monitoring an energy storage cell abnormality, comprising: obtaining valid state data of a first cell of a plurality of cells in a battery module at a preset time; obtaining a discrete statistical state characteristic of the first cell based on the valid state data of the first cell; calculating distances between the discrete statistical state characteristic of the first cell and discrete statistical state characteristics of each remaining cells of the plurality of cells in the battery module separately, averaging said distances to obtain a distance characteristic associated with the first cell; and determining whether the first cell is abnormal based on the distance characteristic associated with the first cell.

A second aspect of the present disclosure provides an apparatus for monitoring an energy storage cell abnormality, comprising: a data obtaining module, configured to obtain valid state data of cells in a battery module at a preset time; a state characteristic obtaining module, configured to obtain a discrete statistical state characteristic of each of the cells in the battery module based on the valid state data of the cell; a distance characteristic calculation module, configured to calculate distances between the discrete statistical state characteristic of each of the cells in the battery module and discrete statistical state characteristics of each of other cells in the battery module to obtain a distance characteristic of each of the cells in the battery module; and a monitoring module, configured to determine whether each of the cells in the battery module is abnormal based on the distance characteristic of the cell.

A third aspect of the present disclosure provides an electronic device, comprising: a memory, storing instructions; and a processor, configured to load the instructions from the memory to perform the method for monitoring the energy storage cell abnormality as described above.

A fourth aspect of the present disclosure provides a non-transitory computer-readable storage medium, storing a computer program, wherein when the computer program is executed by an electronic device, the method for monitoring the energy storage cell abnormality as described above.

### BRIEF DESCRIPTION OF THE DRAWINGS

FIG. 1 is a schematic diagram of an application scenario of a method for monitoring energy storage cell abnormality according to an embodiment of the present disclosure.

FIG. 2a is a flowchart of the method for monitoring energy storage cell abnormality according to an embodiment of the present disclosure.

FIG. 2b shows a voltage vs time curve of an energy storage cell in a charging period according to an embodiment of the present disclosure.

FIG. 2c is a scatter diagram of a distance characteristic of a cell according to an embodiment of the present disclosure.

FIG. 2d is a box diagram of a distance characteristic from a cell according to an embodiment of the present disclosure.

FIG. 3 is a block diagram showing the structure of an apparatus for monitoring energy storage cell abnormality according to an embodiment of the present disclosure.

FIG. 4 is a block diagram showing the structure of an electronic device according to an embodiment of the present disclosure.

### DETAILED DESCRIPTION

The embodiments of the present disclosure will be described below. Those skilled can easily understand disclosure advantages and effects of the present disclosure according to contents disclosed by the specification. The present disclosure can also be implemented or applied through other different specific embodiments. Various details in this specification can also be modified or changed based on different viewpoints and disclosures without departing from the spirit of the present disclosure. It should be noted that the following embodiments and the features of the following embodiments can be combined with each other if no conflict will result.

It should be noted that the drawings provided in this disclosure only illustrate the basic concept of the present disclosure in a schematic way, so the drawings only show the components closely related to the present disclosure. The drawings are not necessarily drawn according to the number, shape, and size of the components in actual implementation; during the actual implementation, the type, quantity, and proportion of each component can be changed as needed, and the layout of the components can also be more complicated.

The following embodiments of the present disclosure provide a method and an apparatus for monitoring energy storage cell abnormality, an electronic device, and a medium. The apparatus for monitoring energy storage cell abnormality may be specifically integrated in the electronic device, and the electronic device may be a device such as a terminal and a server. The terminal may be, for example, a mobile phone, a tablet computer, an intelligent Bluetooth device, a notebook computer, and a personal computer (PC). The server may be a single server, or a server cluster including a plurality of servers.

In some embodiments, the apparatus for monitoring energy storage cell abnormality may further be realized by a plurality of electronic devices. For example, the apparatus for monitoring energy storage cell abnormality may be realized by a plurality of servers, and the method for monitoring energy storage cell abnormality of the present disclosure is implemented by the plurality of servers.

In some embodiments, the servers may also be terminals.

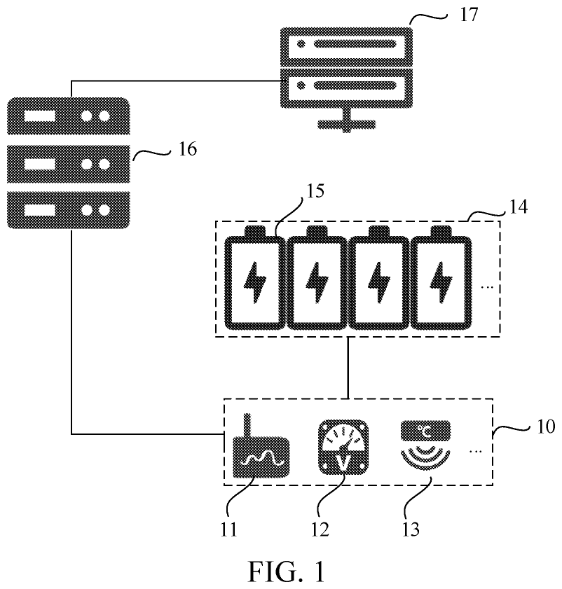

The method for monitoring energy storage cell abnormality of the present disclosure may be applied to an application environment as shown in FIG. 1. The sensor module 10 in FIG. 1 comprises a current sensor 11, a voltage sensor 12, a temperature sensor 13, and the like. The sensor module 10 is configured to monitor state data of each cell 15 in a battery module 14. The sensor module 10 is connected to a server 16. The server 16 is connected to a monitoring platform 17. The monitoring platform 17 may receive cell abnormality monitoring information sent by the server 16 and issue a warning based on cell abnormality monitoring information. The server 16 may comprise a processor, a memory, and the like. The server 16 may obtain valid state data of each cell in the battery module at a preset time, obtain a discrete statistical state characteristic of each cell in the battery module based on the valid state data of the cell, calculate distances between the discrete statistical state characteristic of each cell in the battery module and the discrete statistical state characteristics of other cells in the battery module to obtain a distance characteristic from each cell in the battery module; and determine whether each cell in the battery module is abnormal based on the distance characteristic from the cell.

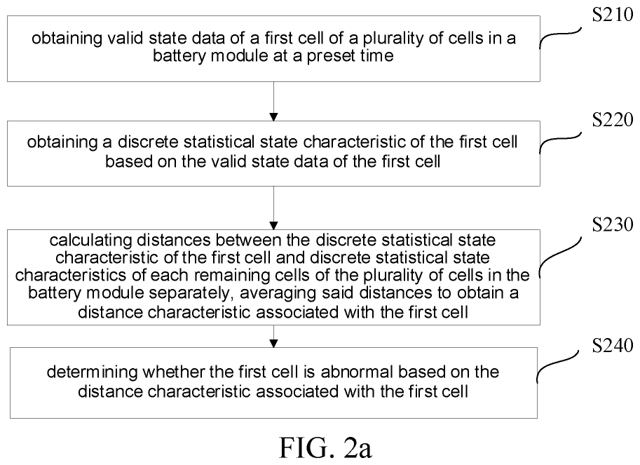

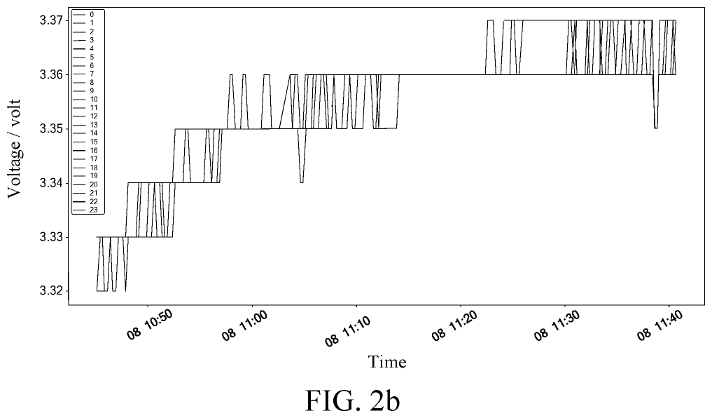

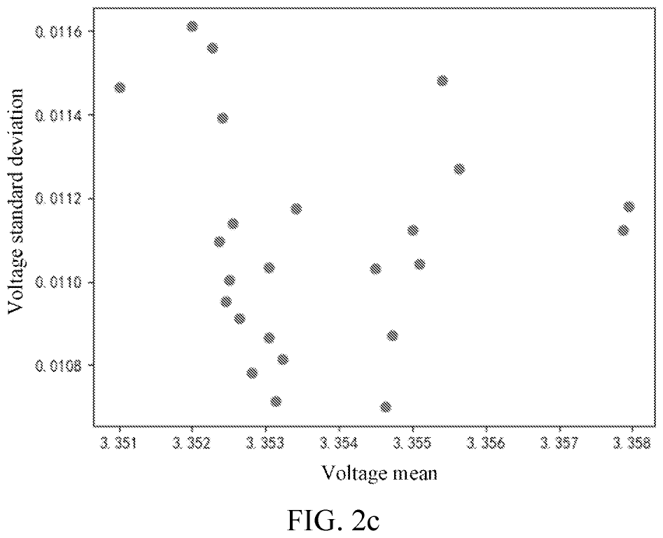

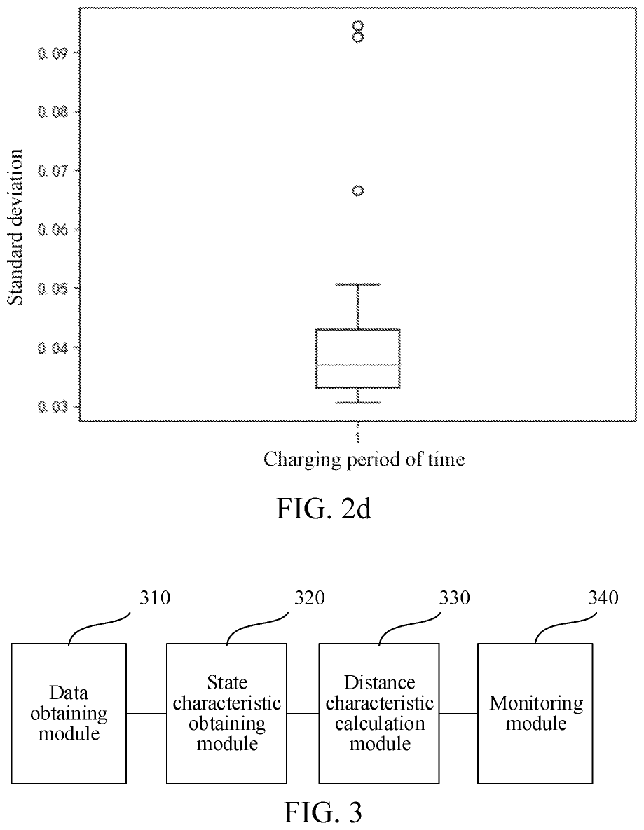

As shown in FIG. 2a, the method for monitoring energy storage cell abnormality specifically comprises step S210 to step S240.

S210: obtaining the valid state data of each cell in the battery module at the preset time.

As an example, each energy storage power station comprises a plurality of battery modules. Each of the battery modules comprises a plurality of cells. The cells may be battery cores. When a plurality of cells, that is, a plurality of battery cores, is packaged together by the same housing frame and connected to the outside through a unified boundary, one battery module is formed.

As an example, each of the cells may also be a battery submodule, and the battery submodule comprises a plurality of battery cores.

In the present disclosure, degrees of consistency among the battery submodules are calculated, and degrees of consistency among battery cores of each of the battery submodules are also calculated. According to the present disclosure, different types of cells may be monitored. The present disclosure is not only applicable to independent individual battery modules, but also modules connected in series. Through comparison inside each module, faulty battery cores may be located. Through direct comparison of the modules connected in series, faulty modules may be located.

The valid state data of each cell may comprise a voltage, a charging current, a discharging current, and a temperature of the cell. The preset time may be a historical time, or may be a real time. The valid state data of each cell may be historical valid state data, or may be real-time valid state data.

As an example, the method for monitoring energy storage cell abnormality further comprises:

obtaining state data of each cell in the battery module at a preset time; and preprocessing the state data to obtain valid state data of the cell. Preprocessing the state data comprises: categorizing the state data based on different working conditions to obtain categorized valid state data of the cell.

As an example, the working conditions may comprise a charging working condition, a discharging working condition, a standing working condition, and the like. The state data of each cell is categorized based on different working conditions so as to separately process the valid data of the cell for different working conditions, so that the specific working condition in which a problem often occurs can be effectively located

As an example, preprocessing the state data to obtain the valid state data of each cell comprises: deleting an abnormal value from the state data; deleting a duplicate value from the state data; and deleting a blank value from the state data.

The state data is preprocessed to ensure the validity and availability of the state data, thereby further improving accuracy of abnormality monitoring of the cell.

S220: obtaining a discrete statistical state characteristic of each cell in the battery module based on the valid state data of the cell.

As an example, a plurality of first discrete statistical values from each cell in the battery module is calculated based on the valid state data of the cell. The plurality of discrete statistical values from each cell in the battery module are used as the discrete statistical state characteristic of the cell.

In the present disclosure, the plurality of first discrete statistical values comprises one or more of a mean of the state data, a variance of the state data, a standard deviation of the state data, and a standard score of the state data. The plurality of discrete statistical values from each cell in the battery module can be calculated based on the valid state data of the cell, and then the plurality of discrete statistical values from each cell in the battery module is used as the discrete statistical state characteristic of the cell.

A mean is an arithmetic average of a series of data numbers, which reflects a trend of the series and is equal to a sum of valid values divided by the number of the valid values. A variance is a measure of a degree of dispersion during measurement of a random variable or a set of data in probability theory and statistics. The variance in probability theory is used to measure a degree of deviation between a random variable and a mathematical expectation (that is, the mean). The variance (sample variance) in statistics is an average of squared differences between each sample value and an average of all sample values. The standard deviation is an arithmetic square root of the variance, which can reflect the degree of dispersion of a data set. The standard score is a relative position quantity derived from the original score, and is used to describe the relative position of the original score in the batch of scores to which it belongs. The standard score z is given by

$$z = \frac{X - \overline{X}}{S} ,$$

where X is raw scores, X̅ is an average of the raw scores, and S is a standard deviation of the raw scores.

As an example, the raw score in the standard score formula of the state data corresponds to the valid state data of the cell. The standard score of the state data may be a standard score of voltage state data or a standard score of temperature state data, the mean of state data may be an average of voltage state data or an average of temperature state data, and the variance of state data may be a variance of voltage state data or a variance of temperature state data.

FIG. 2b shows a voltage vs time curve of a cell in a charging period. The preset time is from a moment t1 to a moment tn, the number of cells in a battery module is i, voltage state data of each cell at the moment t1 comprise a voltage t1_1 to a voltage t1_i, voltage state data of each cell at the moment tn comprise a voltage tn_1 to a voltage tn_i, and so on. Then a mean and a variance of a plurality of pieces of voltage state data of each cell from the moment t1 to the moment tn are calculated. For example, a mean of voltage state data of Cell a from the moment t1 to the moment tn is given by

$${Mean}_{a} = \frac{\sum ( t1\_ 1 + … + tl\_n )}{n} ,$$

a variance of voltage state data of Cell a from the moment t1 to the moment tn is given by

$${Var}_{a} = \frac{{( t1\_ 1 - {Mean}_{a} )}^{2} + .. {( t1\_n - {Mean}_{a} )}^{2}}{n} .$$

S230: calculating distances between a discrete statistical state characteristic of each cell in the battery module and the discrete statistical state characteristics of the remaining cells in the battery module separately, to obtain a distance characteristic from each cell in the battery module.

S230 further comprises: calculating the distances between the discrete statistical state characteristic of a first cell in the battery module and the discrete statistical state characteristics of the other cells to obtain a distance data set the first cell; and accumulating all data in the distance data set the first cell to obtain the distance characteristic from the first cell.

As an example, calculating the distances between the discrete statistical state characteristic of the first cell in the battery module separately and the discrete statistical state characteristics of each of the remaining cells to obtain the distance data set from the first cell comprises: first determining the first cell and a second cell in the battery module; calculating the distance between the discrete statistical state characteristic of the first cell and the discrete statistical state characteristics of the second cell to obtain a datum of the distance data set of the first cell, where this datum represents the discrete statistical state characteristic of the first cell and the discrete statistical state characteristic of the second cell; determining a next second cell in the battery module, repeating the above processes for the first cell and the next second cell, until all the other cells in the battery modules have been traversed; accumulating all data in the distance data set from the first cell to obtain the distance characteristic from the first cell; storing the distance characteristic from the first cell; and determining a next first cell in the battery module, and repeating the above processes until all the cells in the battery module has been traversed to obtain an distance characteristic for each cell in the battery module.

As an example, calculating the distances between the discrete statistical state characteristic of the first cell and the discrete statistical state characteristics of the other cells to obtain a distance data set from the first cell comprises: obtaining the discrete statistical state characteristic of the first cell and the discrete statistical state characteristic of a second cell selected from the remaining cells in the battery module; calculating a Euclidean distance between the discrete statistical state characteristic of the first cell and the discrete statistical state characteristic of the second cell, to obtain a Euclidean distance value from the first cell; and recording the Euclidean distance value from the first cell as a datum in the distance data set from the first cell.

Specifically, as shown in FIG. 2c, as an example, a distance characteristic scatter diagram may be drawn by using a mean of voltage state data of the cells as an abscissa and a standard deviation of the voltage state data as an ordinate. Each point in FIG. 2c represents a cell's data, and an abscissa value of the cell is a mean of the state data, and an ordinate value of the cell is a standard deviation of the state data. Then distances between each point and other points in the scatter diagram are calculated and accumulated.

For example, i cells are provided. i-1 distance values may be obtained through calculation of distances between Cell a and other cells in a coordinate system in the scatter diagram, and then a distance characteristic from Cell a may be obtained through accumulation of the i-1 distance values. Specifically, the distance between Cell a and Cell b of the other cells in the scatter diagram is: D_{ab}=\sqrt{(x1−x2)²+(y1−y2)²}, where (x1, y1) is coordinates of Cell a in the scatter diagram, x1 represents a mean of state data of Cell a, and y1 represents a standard deviation of the state data of Cell a. (x2, y2) is coordinates of Cell b in the scatter diagram, x2 represents a mean of state data of Cell b, and y2 represents a standard deviation of the state data of Cell b. As an example, the scatter diagram may alternatively be drawn by using a mean of state data of the cells as an abscissa and a variance or a standard score of the state data as an ordinate.

S240: determining whether each cell in the battery module is abnormal based on the distance characteristic from the cell.

As an example, S240 comprises: obtaining a discrete statistical distance characteristic from each cell in the battery module based on the distance characteristic from the cell; and determining that the cell is abnormal when the discrete statistical distance characteristic from the cell is greater than a preset threshold.

As an example, obtaining the discrete statistical distance characteristic from each cell in the battery module based on the distance characteristic from the cell comprises: calculating a plurality of second discrete statistical values from each cell in the battery module based on the distance characteristic from the cell; and using the plurality of second discrete statistical values from each cell as the discrete statistical distance characteristic from the cell.

As an example, the plurality of second discrete statistical values comprises a variance of the distance characteristic, a standard deviation of the distance characteristic, a standard score of the distance characteristic, and the like. In the present disclosure, the plurality of second discrete statistical values from each cell in the battery module can be calculated based on the distance characteristic from the cell. Then the plurality of second discrete statistical values from the cell are used as the discrete statistical distance characteristic from the cell, which is then used for assessing the degree of consistency of the cell.

For example, because the difference between a voltage of an abnormal cell and a voltage of a normal cell is relatively small, it is very difficult to determine degrees of inconsistency inside the battery module by using this difference. However, the variance, the standard deviation, or the standard score calculated by using the above method presents an accumulation of the difference for several times or even dozens of times, so that a threshold can be easily determined, the abnormal cell can be clearly identified, and the cells can be easily categorized based on the degree of inconsistency.

Specifically, the distance characteristic from the state data obtained based on statistics collected on the normal cells is used as a discrete reference value, and the second discrete statistical value of each cell is compared with the discrete reference value. If the second discrete statistical value of a certain cell is less than or equal to the discrete reference value, it is determined that the cell operates normally. When the second discrete statistical value is greater than the discrete reference value, it is determined that the states inside the cell are inconsistent. Specifically, when the discrete statistical value is greater than three times the discrete reference value, it is determined that the cell has poor consistency. As an example, a box diagram may further be drawn based on the distance characteristic from each cell. As shown in FIG. 2d, three abnormal values appear in an upper part of the box, indicating that there are three cells, each of which has inconsistent states.

According to the present disclosure, the state data of the cells in the battery module is converted into coordinate points of a two-dimensional plane, so that a scatter diagram of the cells can be drawn, then distances between each point in the scatter diagram and peripheral points are calculated, and then the distance values are accumulated, so as to obtain a corresponding distance characteristic of each cell. Then, the discrete statistical value of the distance characteristic from each cell is calculated, and whether the cell is abnormal is determined by using the discrete statistical value of the distance characteristic from the cell. In the present disclosure, whether inside of the battery module is abnormal can be determined by drawing a box diagram, which has high warning accuracy.

According to the present disclosure, consistency monitoring of each cell in the battery module is implemented based on the state data of each cell, so that an early warning indicative of a possible fault can be issued. According to the present disclosure, the cell that may go wrong can be positioned more quickly, which effectively improves safety, economy, and monitoring efficiency of the battery module operation. According to the present disclosure, the consistency monitoring of the battery may be implemented based on real-time voltage data or historical voltage data. The present disclosure is applicable to cells of different models, different quantities of cells, cells from different manufacturers, and cells in different working conditions.

The execution orders of various steps enumerated in the present disclosure are only examples of the presently disclosed techniques, and are not intended to limit aspects of the presently disclosed invention. Any omission or replacement of the steps, and extra steps consistent with the principles of the present invention are within the scope of the present disclosure.

The present disclosure further provides an apparatus for monitoring energy storage cell abnormality. Apparatuses that can implement the method described in the present disclosure include but are not limited to those with the structure of the apparatus described herein, and any structural modification and replacement of the current technics made according to the principles of the present disclosure, are included in the scope of the present disclosure.

As shown in FIG. 3, the apparatus for monitoring energy storage cell abnormality comprises: a data obtaining module 310, configured to obtain valid state data of each cell in a battery module at a preset time; a state characteristic obtaining module 320, configured to obtain a discrete statistical state characteristic of each cell in the battery module based on the valid state data of the cell; a distance characteristic calculation module 330, configured to calculate distances between the discrete statistical state characteristic of each cell in the battery module and the discrete statistical state characteristics of other cells to obtain a distance characteristic from the cell in the battery module; and a monitoring module 340, configured to determine whether each cell in the battery module is abnormal based on the distance characteristic from the cell.

In the present disclosure, the valid state data of each cell in a battery module at a preset time is first obtained; the discrete statistical state characteristic of each cell in the battery module is then determined based on the valid state data of the cell; distances between the discrete statistical state characteristic of any cell in the battery module and the discrete statistical state characteristics of other cells are then calculated to obtain the distance characteristic from each cell in the battery module; and it is finally determined whether each cell in the battery module is abnormal based on the distance characteristic from the cell. According to the present disclosure, consistency monitoring of each cell in the battery module is implemented based on the state data of the cell, so that an early warning indicative of a possible fault can be given. According to the present disclosure, the cell that may go wrong can be located more quickly, which effectively improves safety and economy of operation of the battery module. According to the present disclosure, the consistency monitoring of the battery may be implemented based on real-time voltage data or historical voltage data. The present disclosure is applicable to cells of different models, cells from different manufacturers, and cells in different working conditions.

As an example, the apparatus for monitoring energy storage cell abnormality further comprises a preprocessing module. The preprocessing module is configured to: obtain state data of each cell in a battery module at a preset time; and preprocess the state data to obtain valid state data of the cell, where the valid state data of the cell are acquired under certain working condition. Preprocessing the state data comprises: categorizing the state data based on different working conditions to obtain categorized valid state data of the cell.

The state data of each cell is categorized based on different working conditions so as to separately process the valid data of the cell for different working conditions, so that the specific working condition in which a problem often occurs can be effectively identified.

As an example, the state characteristic obtaining module 320 comprises a state characteristic obtaining submodule. The state characteristic obtaining submodule is configured to: calculate a mean of state data of each cell in the battery module based on the valid state data of the cell; calculate a variance of the state data of each cell in the battery module based on the valid state data of the cell; and use the mean of the state data and the variance of the state data of each cell as the discrete statistical state characteristic of the cell.

As an example, the distance characteristic calculation module 330 comprises a distance characteristic calculation submodule. The distance characteristic calculation submodule is configured to: obtain a first cell in the battery module and the remaining cells in the battery module other than the first cell; calculate distances between the discrete statistical state characteristic of the first cell and the discrete statistical state characteristics of each of the other cells to obtain a distance data set from the first cell, where data in the distance data set represents the discrete statistical state characteristic of the first cell and the discrete statistical state characteristic of each of the other cells; and accumulate all data in the distance data set from the first cell to obtain a distance characteristic of the first cell.

According to the present disclosure, the distances between the discrete statistical state characteristic of a first cell in the battery module and the discrete statistical state characteristics of the other cells are respectively calculated, and then the distances between the discrete statistical state characteristic of the first cell and the discrete statistical state characteristics of each remaining cells are accumulated, so that the accumulated value of the discrete statistical state characteristic from the first cell is obtained, and is further used as the distance characteristic from the first cell.

As an example, the distance characteristic calculation submodule comprises a Euclidean distance calculation module. The Euclidean distance calculation module is configured to: calculate distances between the discrete statistical state characteristic of the first cell and the discrete statistical state characteristics of the other cells to obtain a distance data set from the first cell, comprising: obtaining the discrete statistical state characteristic of the first cell and the discrete statistical state characteristic of a second cell out of the remaining cells; calculating a Euclidean distance between a discrete statistical state characteristic of the first cell and the discrete statistical state characteristic of a second cell out of the remaining cells, to obtain a Euclidean distance value from the first cell; and using the Euclidean distance value from the first cell as a piece of data in the distance data set from the first cell.

As an example, the monitoring module 340 comprises a monitoring submodule. The monitoring submodule is configured to: obtain a discrete statistical distance characteristic from each cell in the battery module based on the distance characteristic from the cell; and determine that this cell is abnormal if the discrete statistical distance characteristic from this cell is greater than a preset threshold.

As an example, the monitoring submodule comprises a monitoring calculation module. The monitoring calculation module is configured to: calculate a variance of the distance characteristic from each cell in the battery module based on the distance characteristic from said cell; calculate a standard deviation of the distance characteristic from each cell in the battery module based on the distance characteristic from that cell; and use the variance of the distance characteristic from each cell and the standard deviation of the distance characteristic from that cell as the discrete statistical distance characteristic from that cell.

In the present disclosure, the variance or the standard deviation of the corresponding distance characteristic can be determined by using the distance characteristic from each cell in the battery module, which is then used for assessing the degree of consistency of the cell.

As an example, in the data obtaining module 310, each cell is a battery submodule or a battery core. The battery submodule comprises a plurality of battery cores.

Degrees of consistency among the battery submodules are calculated, and degrees of consistency among battery cores of each of the battery submodules are also calculated. According to the present disclosure, different types of cells may be monitored. The present disclosure is not only applicable to independent individual battery modules, but also modules connected in series. Through comparison inside each module, faulty battery cores may be identified. Through direct comparison of the modules connected in series, faulty modules may be identified.

During the specific implementation, each of the above modules may be implemented as an independent entity, or may be combined as needed and implemented as one entity or a plurality of entities. For the specific implementation of each of the above modules, reference may be made to the foregoing method embodiments.

By the present disclosed apparatus, consistency monitoring of each cell in the battery module is implemented based on the state data of each cell, so that an early warning indicative of a possible fault can be issued. By the present disclosed apparatus, the cell that may go wrong can be identified more quickly, which effectively improves safety, economy, and monitoring efficiency of the battery module operation. By the present disclosed apparatus, the consistency monitoring of the battery may be implemented based on real-time voltage data or historical voltage data. The present disclosed apparatus is applicable to cells of different models, different quantities of cells, cells from different manufacturers, and cells in different working conditions.

It needs to be noted that it should be understood that the division of modules of the above device is only a logical function division, and the modules can be fully or partially integrated into a physical entity or physically separated in the actual implementation. In one embodiment, these modules can all be implemented in the form of software called by processing components. In one embodiment, they can also be all implemented in the form of hardware. In one embodiment, some of the modules can also be realized in the form of software called by processing components, and some of the module can be realized in the form of hardware. For example, a certain module may be a separate processing component, or it may be integrated into a chip of the device, or it may be stored in the memory of the device in the form of codes, and the function of the module may be performed by a processing component of the device. The implementation of other modules is similar. In addition, all or part of these modules can be integrated together, or can be implemented independently. The processing component may be an integrated circuit capable of processing signals. In the implementation process, each step or each module of the above method can be implemented by hardware integrated logic circuits or software instructions in the processing component.

A person of ordinary skill in the art should further realize that steps of units and algorithms of various examples described with reference to the embodiments disclosed in this specification can be implemented in electronic hardware, computer software, or a combination of the electronic hardware and the computer software. In order to clearly describe the interchangeability of hardware and software, the compositions and steps of the various examples have been generally described in terms of functionality in the foregoing description. Whether the functions are executed in a mode of hardware or software depends on particular applications and design constraint conditions of the technical solutions. A person skilled in the art may use different methods to implement the described functions for each particular application, but it should not be considered that the implementation goes beyond the scope of the present disclosure.

The present disclosure further provides an electronic device. The electronic device may be a device such as a terminal or a server. The terminal may be, for example, a mobile phone, a tablet computer, an intelligent Bluetooth device, a notebook computer, and a desktop or laptop PC. The server may be a single server, or a server cluster including a plurality of servers.

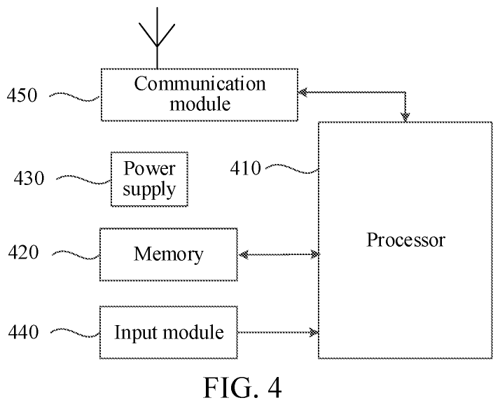

As an example, the electronic device is a server, as shown in FIG. 4, which is a block diagram of a server according to an embodiment of the present disclosure.

Specifically, the server may comprise components such as one or more of a processor 410 with one or more processing cores, a memory 420 with one or more computer-readable storage media, a power supply 430, an input module 440, and a communication module 450.

The processor 410 is a control center of the server, which connects various parts of the entire electronic device by using various interfaces and lines, and executes multiple functions of the server and processes data by running or executing software programs and/or modules stored in the memory 420, and calling data stored in the memory 420, thereby performing overall monitoring on the server. In some embodiments, the processor 410 may comprise one or more processing cores. In some embodiments, the processor 410 may comprise an application processor and a modem processor. The application processor mainly executes an operating system, a user interface, an application program, and the like, and the modem processor mainly executes instructions from wireless communication links. It may be understood that the foregoing modem processor may or may not be integrated into the processor 410.

The memory 420 may be configured to store a software program and a module, and the processor 410 executes various function applications and performs data processing by running the software program and the module stored in the memory 420. The memory 420 may mainly comprise a program storage area and a data storage area. The program storage area may store an operating system, an application program required for at least one function (such as a sound playback function and an image playback function), and the like. The data storage area may store data created according to use of a server, and the like. In addition, the memory 420 may comprise a high-speed random-access memory, and may further comprise a non-volatile memory, such as at least one magnetic disk storage device, a flash memory device, or other non-volatile solid state storage devices. Accordingly, the memory 420 may further comprise a memory controller to provide access to the memory 420 by the processor 410.

The server further comprises a power supply 430 that supplies power to various components. In some embodiments, the power supply 430 may be logically connected to the processor 410 through a power management system, so that functions such as management of charging and discharging and power management can be implemented through the power management system. The power supply 430 may further comprise any component such as one or more direct first or alternating first power supplies, a recharging system, a power failure detection circuit, a power converter or an inverter, a power state indicator, and the like.

The server may further comprise an input module 440. The input module 440 may be configured to receive information about an inputted number or character, and generate inputs of a keyboard, a mouse, a joystick, and an optical or trackball signal that are related to user settings and function control.

The server may further comprise a communication module 450. In some embodiments, the communication module 450 may comprise a wireless module, and the server may perform short-range wireless transmission through a wireless module of the communication module 450, thereby providing wireless broadband Internet access for users. For example, the communication module 450 may be configured to help a user transmit and receive an email, browse a web page, and access streaming media.

Although not shown, the server may further comprise a display unit, and the like. Specifically, as an example, the processor 410 in the server loads executable files from processes of one or more application programs into the memory 420 according to the following instructions, and the processor 410 runs the application programs stored in the memory 420, thereby implementing multiple functions of the apparatus for monitoring the energy storage cell abnormality.

The server may obtain state data of each cell in a battery module at a preset time; then preprocess the state data to obtain valid state data of the cell; then determine a discrete statistical state characteristic of each cell in the battery module based on the valid state data of the cell; then calculate distances between the discrete statistical state characteristic of any cell in the battery module and the discrete statistical state characteristics of other cells to obtain a distance characteristic from each cell in the battery module; and finally determine whether each cell in the battery module is abnormal based on the distance characteristic from the cell. According to the present disclosure, consistency monitoring of each cell in the battery module is implemented based on the state data of each cell, so that an early warning indicative of a possible fault can be issued. According to the present disclosure, the cell that may go wrong can be identified more quickly, which effectively improves safety, economy, and monitoring efficiency of the battery module operation. According to the present disclosure, the consistency monitoring of the battery may be implemented based on real-time voltage data or historical voltage data. The present disclosure is applicable to cells of different models, different quantities of cells, cells from different manufacturers, and cells in different working conditions.

The present disclosure also provides a computer-readable storage medium. A person of ordinary skill in the art would understand that all or some of the steps in the method of implementing the above embodiments can be accomplished by instructing a processor through a program that can be stored in the computer-readable storage medium that is a non-transitory medium, such as a random-access memory, read-only memory, flash memory, hard disk, solid state disk, magnetic tape, floppy disk, optical disc, and any combination thereof. The storage medium may be any available medium that can be accessed by a computer or a data storage device such as a server, data center, etc. that contains one or more available media integrated. The available medium may be a magnetic medium (e.g., a floppy disk, a hard disk, a tape), an optical medium (e.g., a digital video disc (DVD)), or a semiconductor medium (e.g., a solid-state disk (SSD)), and the like.

The present disclosure also provides a computer program product, the computer program product comprising one or more computer instructions. The computer instructions, when loaded and executed on a computing device, produce, in whole or in part, a process or function in accordance with embodiments of the present disclosure. The computer instructions may be stored in a computer-readable storage medium or transmitted from one computer-readable storage medium to another computer-readable storage medium, e.g., the computer instructions may be transmitted from one website, computer, or data center to another website, computer, or data center by wired (e.g., coaxial cable, fiber optic, digital subscriber line (DSL)) or wireless (e.g., infrared, wireless, microwave, etc.) means.

When the computer program product is executed by a computer, the computer performs the methods of the above-described method embodiments. The computer program product may be a software installation package that allows the computer program product to be downloaded and the computer to execute the computer program product on the computer in the event that the implementation of the foregoing method is required.

The description of the process or structure from each of the drawings has different emphases. For the parts that are not detailed in a certain process or structure, reference can be made to the relevant description of other processes or structures.

The above-mentioned embodiments are merely illustrative of the principle and effects of the present application instead of restricting the scope of the present application. Modifications or variations of the above-described embodiments may be made by those skilled in the art without departing from the spirit and scope of the present application. Therefore, all equivalent modifications or changes made by those who have common knowledge in the art without departing from the spirit and technical concept disclosed by the present application shall be still covered by the claims of the present application.

What is claimed is:

1. A method for monitoring an energy storage cell abnormality, comprising:
obtaining valid state data of a first cell of a plurality of cells in a battery module at a preset time;
obtaining a discrete statistical state characteristic of the first cell based on the valid state data of the first cell;
calculating distances between the discrete statistical state characteristic of the first cell and discrete statistical state characteristics of each remaining cells of the plurality of cells in the battery module separately, averaging said distances to obtain a distance characteristic associated with the first cell; and
determining whether the first cell is abnormal based on the distance characteristic associated with the first cell.

2. The method as in claim 1, wherein obtaining the discrete statistical state characteristic of the first cell based on the valid state data of the first cell comprises:
calculating a plurality of first discrete statistical values of the first cell based on the valid state data of the first cell; and
using the plurality of first discrete statistical values of the first cell as the discrete statistical state characteristic of the first cell.

3. The method as in claim 1, wherein calculating the distances between the discrete statistical state characteristic of the first cell and the discrete statistical state characteristics of each remaining cells of the plurality of cells in the battery module separately, averaging said distances to obtain the distance characteristic associated with corresponding to the first cell to obtain the distance characteristic associated with the first cell comprises:
calculating the distances between the discrete statistical state characteristic of the first cell and the discrete statistical state characteristics of all remaining cells of the plurality of cells separately to obtain a distance data set associated with the first cell; and
accumulating all data in the distance data set associated with the first cell to obtain the distance characteristic associated with the first cell.

4. The method as in claim 3, wherein calculating the distances between the discrete statistical state characteristic of the first cell and the discrete statistical state characteristics of each remaining cells of the plurality of cells separately to obtain a distance data set associated with the first cell comprises:
obtaining the discrete statistical state characteristic of the first cell and the discrete statistical state characteristic of a second cell selected from the remaining cells of the plurality of cells in the battery module;
calculating a Euclidean distance between the discrete statistical state characteristic of the first cell and the discrete statistical state characteristic of the second cell, to obtain a Euclidean distance value associated with the first cell; and
recording the Euclidean distance value associated with the first cell as a datum point in the distance data set associated with the first cell.

5. The method as in claim 1, wherein determining whether the first cell is abnormal based on the distance characteristic associated with the first cell comprises:
obtaining a discrete statistical distance characteristic associated with the first cell in the battery module based on the distance characteristic associated with the first cell; and
determining that the first cell is abnormal when the discrete statistical distance characteristic associated with the first cell is greater than a preset threshold.

6. The method as in claim 5, wherein obtaining a discrete statistical distance characteristic associated with the first cell in the battery module based on the distance characteristic associated with the first cell comprises:
calculating a plurality of second discrete statistical values associated with the first cell based on the distance characteristic associated with the first cell; and
using the plurality of second discrete statistical values associated with the first cell as the discrete statistical distance characteristic associated with the first cell.

7. The method as in claim 1, wherein the first cell comprises a battery submodule, wherein the battery submodule comprises a plurality of battery cores.

8. An apparatus for monitoring an energy storage cell abnormality, comprising:
a data obtaining module, configured to obtain valid state data of cells in a battery module at a preset time;
a state characteristic obtaining module, configured to obtain a discrete statistical state characteristic of each of the cells in the battery module based on the valid state data of the cell;
a distance characteristic calculation module, configured to calculate distances between the discrete statistical state characteristic of each of the cells in the battery module and discrete statistical state characteristics of each of other cells in the battery module to obtain a distance characteristic of each of the cells in the battery module; and
a monitoring module, configured to determine whether each of the cells in the battery module is abnormal based on the distance characteristic of the cell.

9. An electronic device, comprising:
a memory, storing instructions; and
a processor, configured to load the instructions from the memory to perform the method for monitoring the energy storage cell abnormality as in claim 1.

10. A non-transitory computer-readable storage medium, storing a computer program, wherein when the computer program is executed by an electronic device, the method for monitoring the energy storage cell abnormality as in claim 1 is implemented.
